(19) United States
(12) Patent Application Publication
(10) Pub. No.: US 2012/0239315 A1
(43) Pub. Date: Sep. 20, 2012

(54) VALVE FAULT TEST SYSTEM

(75) Inventors: Dean Alexander Baker, Clifton Park, NY (US); Steven Di Palma, Sterling, MA (US)

(73) Assignee: GENERAL ELECTRIC COMPANY, Schenectady, NY (US)

(21) Appl. No.: 13/051,228

(22) Filed: Mar. 18, 2011

(51) Int. Cl. G01M 3/28; G06F 19/00

(52) U.S. Cl. 702/51

(57) ABSTRACT

A valve fault test system is disclosed. The system tests for leakage in a valve within a turbine system having a gas turbine and a steam turbine sharing a common shaft, by performing actions including: placing the gas turbine in a control mode; determining a power output for the steam turbine corresponding to the control mode of the gas turbine; preventing steam flow to the steam turbine by providing instructions to close at least one of a steam turbine control valve or a steam turbine stop valve; determining a power output for the steam turbine corresponding to the steam flow being prevented to the steam turbine; and comparing the power output for the steam turbine corresponding to the closed at least one of the control valve or the stop valve to an expected power output for the steam turbine to determine whether a leakage in the valve exceeds a predetermined threshold.

### BACKGROUND OF THE INVENTION

The subject matter disclosed herein relates to a valve fault test system. Specifically, the subject matter disclosed herein relates to testing system for determining whether a valve fault exists. In some embodiment, aspects include a testing system for determining whether a valve leakage exceeds a predetermined threshold in a turbine (e.g., steam turbine) system.

Single-shaft combined cycle turbine configurations conventionally include a steam turbine (ST), gas turbine (GT) and a generator coupled together by a single tandem shaft train. Conventional single-shaft turbine units with a cascading bypass steam system include the ability to bypass steam flow around the ST via a bypass valve, which allows the GT and a steam generator (e.g., a heat recovery steam generator) to operate without admitting all of the system's steam to the steam turbine section(s). This single-shaft system is configured to produce electrical power based upon the amount of rotor torque generated by both the ST and the GT. The rotor torque contribution from the ST may include torque produced by high-pressure (HP), intermediate pressure (IP) and low pressure (LP) turbine sections. The supply of steam to each of these sections, and thus the rotor torque produced by the steam turbine, is regulated by a set of valves. For example, main stop and control valves regulate the flow of high-pressure steam to the HP section, reheat stop and intercept valves regulate the flow of intermediate-pressure steam to the IP and low-pressure steam to the LP section, and LP admission stop and LP control valves regulate the flow of low-pressure steam to the LP section.

Some steam turbine applications, for example, commercial electric utility power generation, entail periods of operation without plant shutdown for periodic maintenance. Unsuspected failures of components such as valves may cause safety issues in operation of the power plant. For example, unsuspected component failures may expose plant personnel (e.g., human operators) to safety hazards, and force the shutdown of a power plant, depriving the utility of a power supply and incurring undesirable costs.

### BRIEF DESCRIPTION OF THE INVENTION

A valve fault test system is disclosed. In one embodiment, the valve fault test system includes at least one computing device adapted to test for leakage in a valve within a turbine system having a gas turbine and a steam turbine sharing a common shaft, the at least one computing device performing actions including: placing the gas turbine in a control mode; determining a power output for the steam turbine corresponding to the control mode of the gas turbine; preventing steam flow to the steam turbine by providing instructions to close at least one of a steam turbine control valve or a steam turbine stop valve; determining a power output for the steam turbine corresponding to the steam flow being prevented to the steam turbine; and comparing the power output for the steam turbine corresponding to the closed at least one of the control valve or the stop valve to an expected power output for the steam turbine to determine whether a leakage in the valve exceeds a predetermined threshold.

A first aspect of the invention includes a valve fault test system having: at least one computing device adapted to test for leakage in a valve within a turbine system having a gas turbine and a steam turbine sharing a common shaft, the at least one computing device performing actions including: placing the gas turbine in a control mode; determining a power output for the steam turbine corresponding to the control mode of the gas turbine; preventing steam flow to the steam turbine by providing instructions to close at least one of a steam turbine control valve or a steam turbine stop valve; determining a power output for the steam turbine corresponding to the steam flow being prevented to the steam turbine; and comparing the power output for the steam turbine corresponding to the closed at least one of the control valve or the stop valve to an expected power output for the steam turbine to determine whether a leakage in the valve exceeds a predetermined threshold.

A second aspect of the invention includes a program product stored on a computer readable medium, which when executed by at least one computing device, performs the following: provides instructions to test for leakage in a valve within a turbine system having a gas turbine and a steam turbine sharing a common shaft, by performing actions including: providing instructions to place the gas turbine in a control mode; determining a power output for the steam turbine corresponding to the control mode of the gas turbine; preventing steam flow to the steam turbine by providing instructions to close at least one of a steam turbine control valve or a steam turbine stop valve; determining a power output for the steam turbine corresponding to the steam flow being prevented to the steam turbine; and comparing the power output for the steam turbine corresponding to the closed at least one of the control valve or the stop valve to an expected power output for the steam turbine to determine whether a leakage in the valve exceeds a predetermined threshold.

A third aspect of the invention includes a system having: a gas turbine; a steam turbine operably connected to the gas turbine by a common shaft; and at least one computing device operably connected to at least one of the gas turbine and the steam turbine, the at least one computing device adapted to test for leakage in a valve by performing actions including: placing the gas turbine in a control mode; determining a power output for the steam turbine corresponding to the control mode of the gas turbine; preventing steam flow to the steam turbine by providing instructions to close at least one of a steam turbine control valve or a steam turbine stop valve; determining a power output for the steam turbine corresponding to the steam flow being prevented to the steam turbine; and comparing the power output for the steam turbine corresponding to the closed at least one of the control valve or the stop valve to an expected power output for the steam turbine to determine whether a leakage in the valve exceeds a predetermined threshold.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows a schematic view of an environment including a power generation system and a valve fault test system according to embodiments of the invention.

FIGS. 2-3 show method flow diagrams illustrating processes according to embodiments of the invention.

FIG. 4 shows an environment including a valve fault test system according to embodiments of the invention.

It is noted that the drawings of the invention are not necessarily to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

Aspects of the invention relate to single-shaft combined cycle turbine configurations, where a steam turbine (ST), gas turbine (GT) and a generator are coupled together by a single tandem shaft train. Conventional single-shaft turbine units with a cascading bypass steam system include the ability to bypass steam flow around the ST via a bypass, which allows the GT and a steam generator (e.g., a heat recovery steam generator) to operate without admitting all of the system's steam to the steam turbine section(s). This single-shaft system is configured to produce electrical power based upon the amount of rotor torque generated by both the ST and the GT. The rotor torque contribution from the ST may include torque produced by high-pressure (HP), intermediate pressure (IP) and low pressure (LP) turbine sections. The supply of steam to each of these sections, and thus the rotor torque produced by the steam turbine, is regulated by a set of valves. For example, main stop and control valves regulate the flow of high-pressure steam to the HP section, reheat stop and intercept valves regulate the flow of intermediate-pressure steam to the IP and low-pressure steam to the LP section, and LP admission stop and LP control valves regulate the flow of low-pressure steam to the LP section.

As described herein, it may be desirable to determine whether one or more valves in a single-shaft system is functioning as designed, for example, whether a valve fault exists. In one embodiment, aspects of the invention include determining whether a valve leakage exists, and further determining whether that valve leakage exceeds a predetermined threshold. Aspects of the invention provide a system for determining whether the valve(s) leakage exceeds this predetermined threshold, while allowing the single-shaft system to continue operation (electricity generation).

It is understood that as used herein, aspects of the invention may include testing the health of one or more valves in a power generation system. While the term “leak” or “leakage” is used herein, it is understood that aspects of the invention may include determining whether a valve in a power generation system is experiencing a fault in its operation (e.g., a fault in controlling the flow of a working fluid). These faults may be caused by a number of conditions, e.g., a leak in one or more seals or conduits connected to the valve, an inability to close the valve as designed, etc. In any case, aspects of the invention are directed toward detecting these faults via the processes and systems described herein.

In one general embodiment, a valve fault test system isolates steam from one or more respective steam turbine sections (e.g., HP, IP and/or LP) by closing the valve(s) associated with each section. This may be accomplished by closing the control valves, the stop valves, or both, for one or more sections. Isolating steam from a turbine section will reduce the torque on the steam turbine shaft train, thereby reducing steam turbine power output. This change in steam turbine power output can be measured and compared to a predetermined change in power output (as calculated based upon an acceptable leakage in one or more valves) to determine whether one or more valves is experiencing an excessive leak (e.g., a leak exceeding a predetermined allowable threshold). In some embodiments, steam turbine power output may be calculated based upon measurements including, but not limited to, generator electrical power, turbine shaft torque, steam flow through one or more steam turbine sections, or steam turbine pressure in one or more steam turbine sections.

In one embodiment, aspects of the invention provide for a valve fault test system configured to perform the following: place the gas turbine in a control mode; determine a power output for the steam turbine corresponding to the control mode of the gas turbine; prevent steam flow to the steam turbine by providing instructions to close at least one of a steam turbine control valve and a steam turbine stop valve; determine a power output for the steam turbine corresponding to the steam flow being prevented to the steam turbine; and compare the power output for the steam turbine corresponding to the closed at least one of the control valve or the stop valve to an expected power output for the steam turbine to determine whether a leakage in the valve exceeds a predetermined threshold.

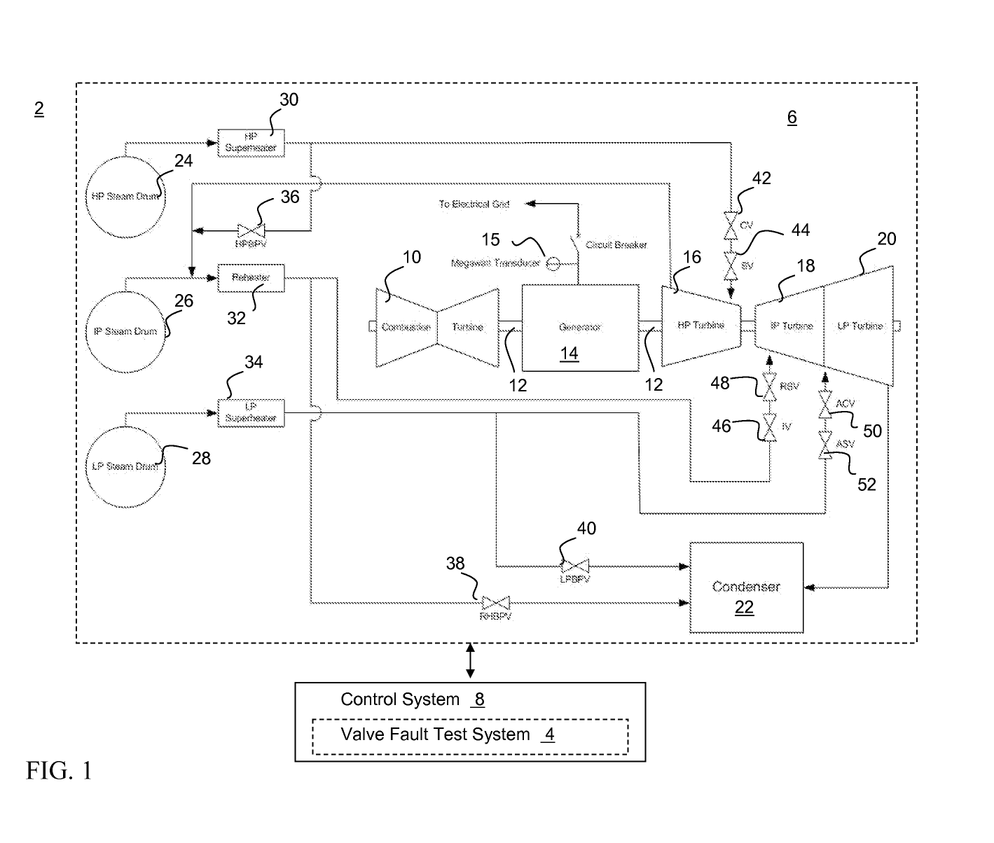

Turning to the FIG. 1, an illustrative schematic environment 2 is shown including a valve fault test system 4 according to embodiments of the invention. As shown, valve fault test system 4 may be connected (e.g., via hard-wired and/or wireless means) to a power generation system 6, which may include one or more conventional components in a power generation system. As will be described further herein, valve fault test system 4 may be part of a control system 8, such as a conventional control system employed to regulate and/or monitor activity of components in a conventional power generation system (e.g., turbines, generators, valves, steam generators, condensers, etc.). In other embodiments (as indicated in phantom), valve fault test system 4 may be part of a separate computer system or software package, apart from control system 8.

As shown, valve fault test system 4 is configured to communicate with components in power generation system 6, which may include: a gas (or, combustion turbine) (GT) 10, sharing a common shaft 12 with a generator 14 (electrically coupled to a megawatt transducer 15), a high pressure (HP) steam turbine 16, an intermediate pressure (IP) steam turbine 18 and a low pressure (LP) steam turbine 20. As shown, this single-shaft (e.g., shaft 12) combined-cycle system may include a plurality of components (e.g., driving components such as turbines and driven components such as one or more generators) connected via a common shaft. The term “common shaft” does not necessarily depict a single, continuous piece of material (e.g., steel), but merely depicts that the driving/driven functions of one or more of the components connected to that shaft will be transferred to the neighboring component along the shaft 12. Also shown included in the power generation system 6 are condenser 22, drums (HP steam drum 24, IP steam drum 26 and LP steam drum 28) fluidly connected to the HP turbine 16, IP turbine 18 and LP turbine 20, respectively. Power generation system 6 further includes an HP superheater 30, a reheater 32, and an LP superheater 34, fluidly connected to the HP turbine 16, IP turbine 18 and LP turbine 20, respectively. Also shown are a plurality of valves. For example, an HP bypass valve (HPBPV) 36 is shown, which when actuated as open will allow high-pressure steam to bypass the HP turbine 16. Similarly, when actuated as open, a reheat bypass valve (RHBPV) 38 may allow for intermediate pressure steam from the reheater 32 to bypass the IP turbine 18 and LP turbine 20 and enter the condenser 22. Additionally, when actuated as open, a low pressure bypass valve (LPBPV) 40 may allow for low pressure steam to bypass the LP turbine 20 and enter the condenser 22.

Also shown included in power generation system 6 are control valves and stop valves associated with each of the HP turbine 16, IP turbine 18 and LP turbine 20. Specifically shown are the following: a control valve (CV) 42 and a stop valve (SV) 44 for the HP turbine 16; a control valve (IV) 46 and stop valve (RSV) 48 for the IP turbine 18; and a control valve (ACV) 50 and stop valve (ASV) 52 for the LP turbine 20. Components shown in power generation system 6 may be conventional components, and as such, their functions may be omitted herein for clarity.

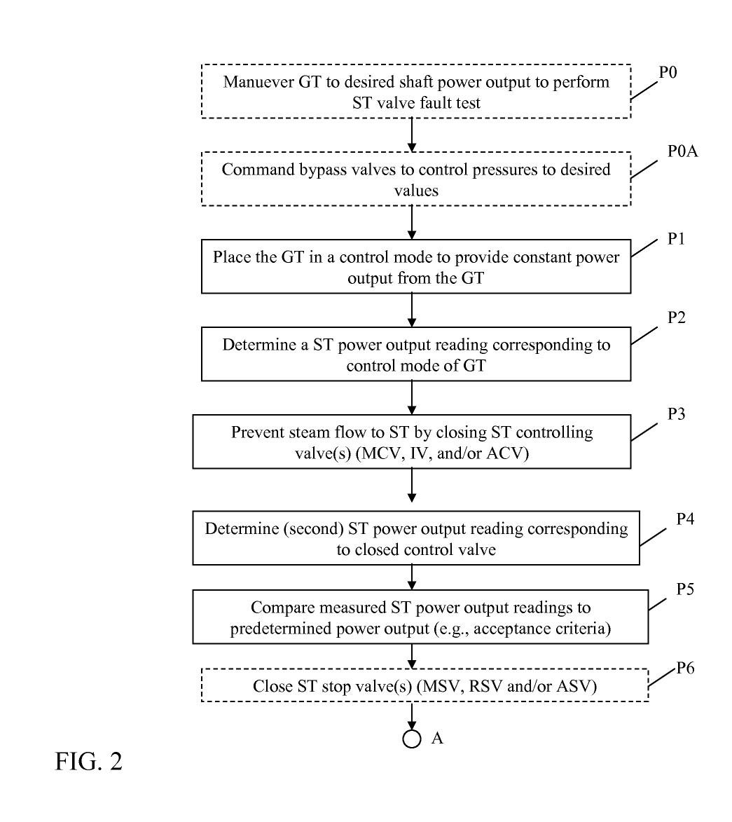

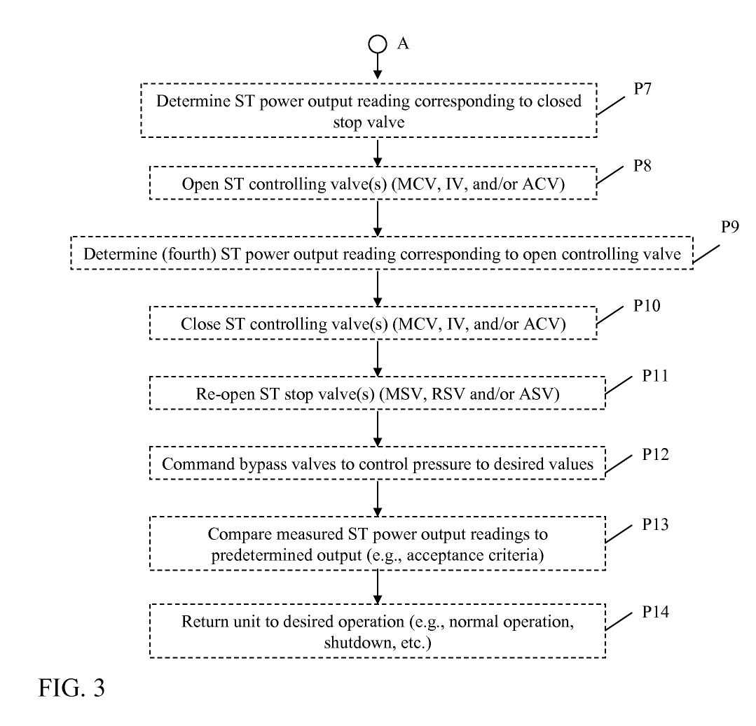

Valve fault test system 4 may be configured to perform the actions described herein according to certain embodiments of the invention. These actions will be described with reference to FIGS. 2-3, which collectively depict a process performed according to embodiments of the invention. It is understood that some processes depicted in FIGS. 2-3 may be optionally performed, or pre-performed, and that those optional processes and/or pre-processes may be depicted using phantom lines.

Turning to FIGS. 2-3, the following processes may be performed by valve fault test system 4 according to embodiments of the invention: In pre-process P0, the gas turbine (GT) 10 is maneuvered to reach a desired shaft (e.g., shaft 12) output power for performing a steam turbine valve fault test. That is, the gas turbine (GT 10) power output may be modified (either increased or decreased) in order to reach a predetermined shaft 12 power output for performing the valve fault test described herein. Following pre-process P0, in pre-process P0A, bypass valves (e.g., HPBPV 36, RHBPV 38 and/or LPBPV 40) for one or more pressure levels (e.g., high pressure, intermediate pressure, low pressure and/or any other applicable pressure levels) are commanded to control the pressures to one or more turbines (e.g., HP 16, IP 18 and/or LP 20) to a desired value for performing the valve fault test. Following the pre-processes P0 and P0A, in process P1, the gas turbine 10 is placed in a control mode to provide a constant power output from the gas turbine 10. That is, the gas turbine 10 is commanded to provide a steady power output for the purposes of performing the valve fault test. After process P1, process P2 includes determining a steam turbine (e.g., HP 16, IP 18 and/or LP 20) power output reading corresponding to the control mode of the gas turbine 10. In one embodiment, the steam turbine's power output may be determined from, but not limited to, the output of the electrical generator 14 connected to the common shaft 12, steam turbine (e.g., HP 16, IP 18 and/or LP 20) shaft torque, steam flow through the steam turbine (e.g., HP 16, IP 18 and/or LP 20), or pressure in the steam turbine (e.g., HP 16, IP 18 and/or LP 20). These may all be measured by conventional means, e.g., optical sensors, pressure sensors, piezoelectric material sensors, etc. Process P3 includes preventing steam flow to the steam turbine(s) (e.g., HP 16, IP 18 and/or LP 20) by closing at least one of the steam turbine control valves (e.g., CV 42, IV 46 and/or ACV 50). Process P4 includes determining a steam turbine (e.g., HP 16, IP 18 and/or LP 20) power output reading (e.g., a second reading) corresponding to the closed control valve (e.g., CV 42, IV 46 and/or ACV 50) (or, the steam flow being prevented to the steam turbine).

That is, process P4 includes determining (e.g., measuring) an output reading of the steam turbine (e.g., HP 16, IP 18 and/or LP 20) while the control valves (e.g., CV 42, IV 46 and/or ACV 50) are closed. This determining of the steam turbine (e.g., HP 16, IP 18 and/or LP 20) output may be performed similarly as described with reference to process P2, or may be performed by another conventional method. Following process P4, process P5 may include comparing the measured (or simulated) power output for the steam turbine (e.g., HP 16, IP 18 and/or LP 20) corresponding to the closed valve(s) (e.g., CV 42, IV 46 and/or ACV 50) to an acceptable (predetermined) power output for the steam turbine (e.g., HP 16, IP 18 and/or LP 20) to determine whether a leak in the valve(s) (e.g., CV 42, IV 46 and/or ACV 50) exceeds a predetermined threshold. In one embodiment, process P5 may include comparing the power output for the steam turbine (e.g., HP 16, IP 18 and/or LP 20) to an expected power output derived from the control mode of the gas turbine 10. That is, the expected power output for the steam turbine (e.g., HP 16, IP 18 and/or LP 20) may be based upon the constant power output of the gas turbine 10.

It is understood that in one example embodiment, the expected power output for the steam turbine may be derived based upon a measured (actual) output of the gas turbine, and/or a predicted (expected) output of a gas turbine coupled to the steam turbine. That is, in one embodiment, a gas turbine power output may be measured (e.g., via conventional sensors) in terms of its contribution to the generator output. In another embodiment, the gas turbine power output may be predicted based upon a model (e.g., a computer model and/or manually calculated model) representing the gas turbine. That is, the model may predict the gas turbine's contribution to the overall system power output by using parameters such as flow, temperature, efficiency loss, measurement error, etc. Based upon the gas turbine's actual or expected contribution to the system, the steam turbine's contribution may be derived (e.g., via actual measurement and/or modeling). In another embodiment, modeling or actual measurement of the gas turbine power contribution may be unnecessary, as a torque collar applied to the steam turbine, and/or a steam turbine model, may also be used to determine the expected power contribution to the overall system from the steam turbine. It is understood that the modeling and/or measurement described herein may be applied to any combination of steam turbine sections (e.g., HP 16, IP 18 and/or LP 20).

Additionally, it is understood that measurement (actual) and prediction (estimation model) calculations may be compared to determine a delta, or deviation from an expected power output of the gas turbine and/or any of the steam turbine sections. This determined deviation value may be compared to an acceptable deviation value to determine whether the deviation is within the “acceptable” limits. The “acceptable” values/limits may be determined by, e.g., safety criteria and/or other diagnostic criteria for valve faults.

Following determining of the steam turbine (e.g., HP 16, IP 18 and/or LP 20) power output corresponding to the closed control valve (e.g., CV 42, IV 46 and/or ACV 50) (P4) and comparing of the measured steam turbine (e.g., HP 16, IP 18 and/or LP 20) power output to the acceptable power output (P5), the stop valves (e.g., SV 44, RSV 48 and/or ASV 52) may be tested for leakage as well. In this case, additional process P6 includes closing the steam turbine stop valve(s) (e.g., SV 44, RSV 48 and/or ASV 52), and in process P7 (FIG. 3), determining a steam turbine power output reading corresponding to the closed stop valve (e.g., SV 44, RSV 48 and/or ASV 52). It is understood that this process may further include comparing the measured steam turbine power output to the predetermined acceptable power output, however, in some embodiments, this may be performed as one combined step after determining multiple (or all) power output readings described in the process herein. In some embodiments, after determining the steam turbine power output reading corresponding to the closed stop valve, that steam turbine power output reading may be compared to an expected power output derived from the control mode of the gas turbine 10 (as described with reference to process P5). It is understood that this process may further include comparing the measured steam turbine power output to the acceptable power output, however, in some embodiments, this may be performed as one combined step after determining multiple (or all) power output readings described in the process herein. That is, in one embodiment, data (e.g., power output data) may be logged for later analysis and comparison to determine the existence of any valve faults.

Following process P7, process P8 may include opening the steam turbine controlling valve(s) (e.g., CV 42, IV 46 and/or ACV 50), e.g., by providing instructions to open the valve and allow steam flow therethrough. Process P9 may include determining a steam turbine (e.g., HP 16, IP 18 and/or LP 20) power output reading corresponding to the open controlling valve(s) (e.g., CV 42, IV 46 and/or ACV 50), and the closed stop valve (e.g., SV 44, RSV 48 and/or ASV 52), which may be performed according to any approach described herein for determining steam turbine power output. Process P10 may include closing the steam turbine controlling valve(s) (e.g., CV 42, IV 46 and/or ACV 50), e.g., by providing instructions to close the valve and prevent steam flow therethrough. Process P11 may include re-opening the closed steam turbine stop valve(s) (e.g., SV 44, RSV 48 and/or ASV 52), e.g., by providing instructions to open the valve (e.g., SV 44, RSV 48 and/or ASV 52) and allow steam flow therethrough. In process P12, bypass valves (e.g., HPBPV 36, RHBPV 38 and/or LPBPV 40) for one or more pressure levels (e.g. high pressure, intermediate pressure, low pressure) are commanded to control the pressures to one or more turbines (e.g., HP 16, IP 18 and/or LP 20) to a desired value. In one embodiment, this includes returning the one or more turbine(s) to its desired mode of operation (e.g., normal operation, shutdown, etc.). Process P13 may include comparing the power output for the steam turbine (e.g., HP 16, IP 18 and/or LP 20) to a predetermined power output, which in some cases may be determined based upon the control mode of the gas turbine 10 (e.g., actual performance and/or modeled performance). That is, the expected power output for the steam turbine (e.g., HP 16, IP 18 and/or LP 20) may be based upon the constant power output of the gas turbine 10. It is further understood that process P13 may include comparing each of the determined steam turbine power outputs (e.g., four separate readings described herein, where more may be additionally obtained) with one another, and/or with one or more predetermined power outputs. That is, each steam turbine power output reading may be stored, e.g., in a log or file, and may be compared with other steam turbine power output readings, or with an expected power output reading associated with those steam turbine conditions. In process P14, the power generation system 6 is taken out of the valve fault testing operation mode, and returned to its desired mode of operation (e.g., normal operation, shutdown, etc.).

It is understood that while methods described herein may be performed using at least one computing device, portions or all of the methods described herein may be performed manually. That is, logging of the power output data, predicting expected values, comparing those values to one another and/or actuating different modes of the elements of the power generation system 6 may be performed manually (e.g., via hand by a human operator). It is further understood that the processes described herein may, in some embodiments, be periodically repeated (e.g., automatically or by operator prompting) in order to gather and/or compare data relating to valve faults.

As will be appreciated by one skilled in the art, the valve fault test system described herein may be embodied as a system(s), method(s) or computer program product(s), e.g., as part of a control system. Accordingly, embodiments of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, or device. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments of the present invention are described herein with reference to data flow illustrations and/or block diagrams of methods, apparatus (systems) and computer program products according to embodiments of the invention. It will be understood that each block of the data flow illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

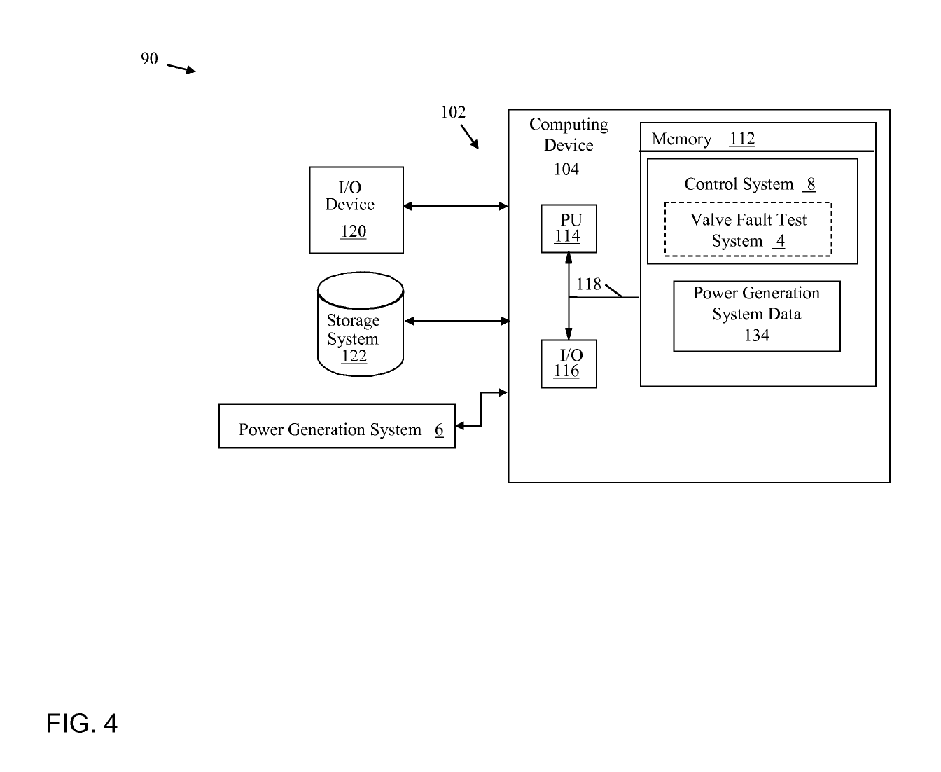

Turning to FIG. 4, an illustrative environment 90 including a valve fault test system 4 is shown according to embodiments of the invention. Environment 90 includes a computer infrastructure 102 that can perform the various processes described herein. In particular, computer infrastructure 102 is shown including a computing device 104 that comprises the end device configuration system 4, which enables computing device 104 (e.g., via control system 8) to test valves within a power generation system (e.g., power generation system 6).

Computing device 104 is shown including a memory 112, a processor (PU) 114, an input/output (I/O) interface 116, and a bus 118. Further, computing device 104 is shown in communication with an external I/O device/resource 120 and a storage system 122. As is known in the art, in general, processor 114 executes computer program code, such as valve fault test system 4, that is stored in memory 112 and/or storage system 122. While executing computer program code, processor 114 can read and/or write data, such as power generation system data 134, which may include data about operation of one or more components in the power generation system 6. For example, power generation system data 134 may include data about turbine operations (e.g., GT speed, output, flow, pressure, temperature, etc.); generator operations (e.g., output, speed, etc.); ST operations (e.g., output, flow, pressure, temperature, etc.); flow through and/or temperature of one or more components (e.g., valves, compressors, reheaters/superheaters, condensers, etc.); statuses of components (e.g., whether a valve is opened or closed, whether a turbine is engaged with a drive shaft, etc.), etc. to/from memory 112, storage system 122, and/or I/O interface 116. Bus 118 provides a communications link between each of the components in computing device 104. I/O device 120 can comprise any device that enables a user to interact with computing device 104 or any device that enables computing device 104 to communicate with one or more other computing devices. Input/output devices (including but not limited to keyboards, displays, pointing devices, etc.) can be coupled to the system either directly or through intervening I/O controllers.

In some embodiments, as shown in FIG. 1, environment 90 may include the power generation system 6 operably connected to the valve fault test system 4 (and control system 8) through computing device 104 (e.g., via wireless or hard-wired means). It is understood that valve fault test system 4 may further include conventional transmitters and receivers for transmitting and receiving, respectively, data from the power generation system 6.

In any event, computing device 104 can comprise any general purpose computing article of manufacture capable of executing computer program code installed by a user (e.g., a personal computer, server, handheld device, etc.). However, it is understood that computing device 104 and valve fault test system 4 are only representative of various possible equivalent computing devices that may perform the various process steps of the disclosure. To this extent, in other embodiments, computing device 104 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, computer infrastructure 102 is only illustrative of various types of computer infrastructures for implementing the disclosure. For example, in one embodiment, computer infrastructure 102 comprises two or more computing devices (e.g., a server cluster) that communicate over any type of wired and/or wireless communications link, such as a network, a shared memory, or the like, to perform the various process steps of the disclosure. When the communications link comprises a network, the network can comprise any combination of one or more types of networks (e.g., the Internet, a wide area network, a local area network, a virtual private network, etc.). Network adapters may also be coupled to the system to enable the data processing system to become coupled to other data processing systems or remote printers or storage devices through intervening private or public networks. Modems, cable modem and Ethernet cards are just a few of the currently available types of network adapters. Regardless, communications between the computing devices may utilize any combination of various types of transmission techniques.

As previously mentioned and discussed further below, valve fault test system 4 has the technical effect of enabling computing infrastructure 102 to perform, among other things, the valve fault test functions described herein. It is understood that some of the various components shown in FIG. 1 can be implemented independently, combined, and/or stored in memory for one or more separate computing devices that are included in computer infrastructure 102. Further, it is understood that some of the components and/or functionality may not be implemented, or additional schemas and/or functionality may be included as part of environment 90.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A system comprising:
at least one computing device adapted to test for leakage in a valve within a turbine system having a gas turbine and a steam turbine sharing a common shaft, the at least one computing device performing actions comprising:
placing the gas turbine in a control mode;
determining a power output for the steam turbine corresponding to the control mode of the gas turbine;
preventing steam flow to the steam turbine by providing instructions to close at least one of a steam turbine control valve or a steam turbine stop valve;
determining a power output for the steam turbine corresponding to the steam flow being prevented to the steam turbine; and
comparing the power output for the steam turbine corresponding to the closed at least one of the control valve or the stop valve to an expected power output for the steam turbine to determine whether a leakage in the valve exceeds a predetermined threshold.

2. The system of claim 1, wherein the expected power output for the steam turbine is derived from the power output for the steam turbine corresponding to the control mode of the gas turbine.

3. The system of claim 1, wherein the providing of the instructions to close the at least one of the steam turbine control valve or the steam turbine stop valve is performed in response to receiving a command to test the closed one of the steam turbine control valve or the steam turbine stop valve.

4. The system of claim 1, wherein the steam turbine is a high pressure steam turbine, an intermediate pressure steam turbine or a low pressure steam turbine

5. The system of claim 1, wherein the at least one computing device is configured to periodically repeat the placing of the gas turbine in a control mode, the determining of the power output for the steam turbine corresponding to the control mode of the gas turbine, the preventing of the steam flow to the steam turbine, the determining of the power output for the steam turbine corresponding to the steam flow being prevented to the steam turbine, and the comparing of the power output for the steam turbine corresponding to the closed at least one of the control valve or the stop valve to an expected power output for the steam turbine in order to determine whether the leakage in the valve exceeds the predetermined threshold.

6. The system of claim 1, wherein the power output for the steam turbine is determined using at least one of: power output from an electrical generator connected to the common shaft, steam turbine shaft torque, steam flow through the steam turbine, or pressure in the steam turbine.

7. The system of claim 1, wherein the at least one computing device is further adapted to provide instructions to a control system to position at least one steam generator bypass valve to regulate a pressure after placing of the gas turbine in the control mode.

8. A program product stored on a computer readable medium, which when executed by at least one computing device, performs the following:
provides instructions to test for leakage in a valve within a turbine system having a gas turbine and a steam turbine sharing a common shaft, by performing actions comprising:
providing instructions to place the gas turbine in a control mode;
determining a power output for the steam turbine corresponding to the control mode of the gas turbine;
preventing steam flow to the steam turbine by providing instructions to close at least one of a steam turbine control valve or a steam turbine stop valve;
determining a power output for the steam turbine corresponding to the steam flow being prevented to the steam turbine; and
comparing the power output for the steam turbine corresponding to the closed at least one of the control valve or the stop valve to an expected power output for the steam turbine to determine whether a leakage in the valve exceeds a predetermined threshold.

9. The program product of claim 8, wherein the expected power output for the steam turbine is derived from the power output for the steam turbine corresponding to the control mode of the gas turbine.

10. The program product of claim 8, wherein the providing of the instructions to close the at least one of the steam turbine control valve or the steam turbine stop valve is performed in response to receiving a command to test the closed one of the steam turbine control valve or the steam turbine stop valve.

11. The program product of claim 8, wherein the steam turbine is a high pressure steam turbine, an intermediate pressure steam turbine or a low pressure steam turbine.

12. The program product of claim 8, wherein the instructions to test for leakage in the valve within the turbine system are periodically repeated.

13. The program product of claim 8, wherein the power output for the steam turbine is determined using at least one of: power output from an electrical generator connected to the common shaft, steam turbine shaft torque, steam flow through the steam turbine, or pressure in the steam turbine.

14. The program product of claim 8, wherein the instructions to test for the leakage in the valve within the turbine system further include instructions to position at least one steam generator bypass valve to regulate a pressure after placing of the gas turbine in the control mode.

15. A system comprising:
a gas turbine;
a steam turbine operably connected to the gas turbine by a common shaft; and
at least one computing device operably connected to at least one of the gas turbine and the steam turbine, the at least one computing device adapted to test for leakage in a valve by performing actions comprising:
placing the gas turbine in a control mode;
determining a power output for the steam turbine corresponding to the control mode of the gas turbine;
preventing steam flow to the steam turbine by providing instructions to close at least one of a steam turbine control valve or a steam turbine stop valve;
determining a power output for the steam turbine corresponding to the steam flow being prevented to the steam turbine; and
comparing the power output for the steam turbine corresponding to the closed at least one of the control valve or the stop valve to an expected power output for the steam turbine to determine whether a leakage in the valve exceeds a predetermined threshold.

16. The system of claim 15, wherein the expected power output for the steam turbine is derived from the power output for the steam turbine corresponding to the control mode of the gas turbine.

17. The system of claim 15, wherein the providing of the instructions to close the at least one of the steam turbine control valve or the steam turbine stop valve is performed in response to receiving a command to test the closed one of the steam turbine control valve or the steam turbine stop valve.

18. The system of claim 15, wherein the steam turbine is a high pressure steam turbine, an intermediate pressure steam turbine or a low pressure steam turbine.

19. The system of claim 15, further comprising an electrical generator operably connected to the gas turbine and the steam turbine by the common shaft, wherein the power output for the steam turbine is determined using at least one of: power output from the electrical generator, steam turbine shaft torque, steam flow through the steam turbine, or pressure in the steam turbine.

20. The system of claim 15, wherein the at least one computing device is further adapted to provide instructions to position at least one steam generator bypass valve to regulate a pressure after placing of the gas turbine in the control mode.
